(19) United States
(12) Patent Application Publication
(10) Pub. No.: US 2026/0357766 A1
(43) Pub. Date: Nov. 12, 2026

(54) THRUST REVERSER ASSEMBLY

(71) Applicant: General Electric Company, Evendale, OH (US)

(72) Inventors: Eric Barre, Cincinnati, OH (US); Brandon Wayne Miller, Middletown, OH (US); Scott David Hunter, Seattle, WA (US)

(21) Appl. No.: 19/369,573

(22) Filed: Oct. 27, 2025

Related U.S. Application Data
(60) Provisional application No. 63/802,747, filed on May 9, 2025.

(51) Int. Cl. F02K 1/72

(52) U.S. Cl. CPC F02K 1/72; F05D 2220/323; F05D 2240/129; F05D 2260/50

(57) ABSTRACT

A thrust reverser assembly for a gas turbine engine, the thrust reverser assembly including a blocker door rotatably coupled to a translating cowl and a deployment assembly coupled to the blocker door, the deployment assembly including a door link movably coupled to an inner fixed structure and movably coupled to the blocker door, and a rotating apparatus configured to move the door link toward and away from the blocker door, wherein the deployment assembly defines a first length in a stowed position between an end of the door link and an inner fixed structure, wherein the deployment assembly defines a second length in a deployed position between the end of the door link and the inner fixed structure, wherein the first length is different than the second length.

### CROSS-REFERENCE TO RELATED APPLICATIONS

This application is a non-provisional application claiming the benefit of priority under 35 U.S.C. § 119(e) to U.S. Provisional Application No. 63/802,747, filed May 9, 2025, which is hereby incorporated by reference in its entirety.

### FIELD

The present disclosure relates to thrust reversers in a gas turbine engine.

### BACKGROUND

Thrust reverser systems can be employed in gas turbine engines to reduce a landing distance or a load on braking systems of an aircraft. Thrust reverser systems can be bulky, increasing the engine size and weight. For example, some known thrust reverser systems require a relatively large nacelle length, thus increasing propulsion system weight and drag and reducing engine efficiency. Furthermore, as fan sizes increase to improve propulsive efficiency, there is an increasing need to reduce the thickness of the nacelle to reduce drag. Both these effects lead to challenges in developing a thrust reverser system that is more compact than traditionally used to enable overall efficiency benefits for the propulsion system in flight.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary gas turbine engine.

FIG. 2 is a schematic view of a thrust reverser assembly in a stowed position.

FIG. 3 is a schematic view of the thrust reverser assembly of FIG. 2 in an intermediate position.

FIG. 4 is a schematic view of the thrust reverser assembly of FIG. 2 in a deployed position.

FIG. 5 is a schematic view of another thrust reverser assembly in a stowed position.

FIG. 6 is a schematic view of the thrust reverser assembly of FIG. 5 in a deployed position.

FIG. 7 is a schematic view of another thrust reverser assembly.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

As used herein, the terms “first,” “second,” “third,” and other ordinals are used to distinguish one component from another and are not intended to signify location or importance of the individual components.

The terms “forward” and “aft” refer to relative positions within a gas turbine engine, with forward referring to a position closer to an engine inlet and aft referring to a position closer to an engine nozzle or exhaust.

The present disclosure is generally related to a gas turbine engine including an expanding cascade thrust reverser assembly (e.g., stowed in a nacelle of the gas turbine engine in a contracted configuration and deployed to an expanded configuration). The cascade thrust reverser assembly allows for thrust reversal during specific operating conditions of flight. Typically, components of the cascade thrust reverser assembly deflect radially outward based on relative positions of the components. The radially outward deflection introduces space constraints, leading to increased drag and weight for the gas turbine engine. In particular, a single rigid link with a fixed length attached to a blocker door reduces design space for nacelle design, such as nacelle diameter and weight.

By using an actuator to control the length of the link to the blocker door, the design space for nacelle design improves. In particular, controlling the length of the link, such as with another link or with a telescoping actuator, allows for the blocker door to be positioned closer to other components of the thrust reverser, allowing for shorter overall nacelle length and diameter. The shorter overall nacelle length and diameter reduces overall drag and weight, improving operation of the gas turbine engine.

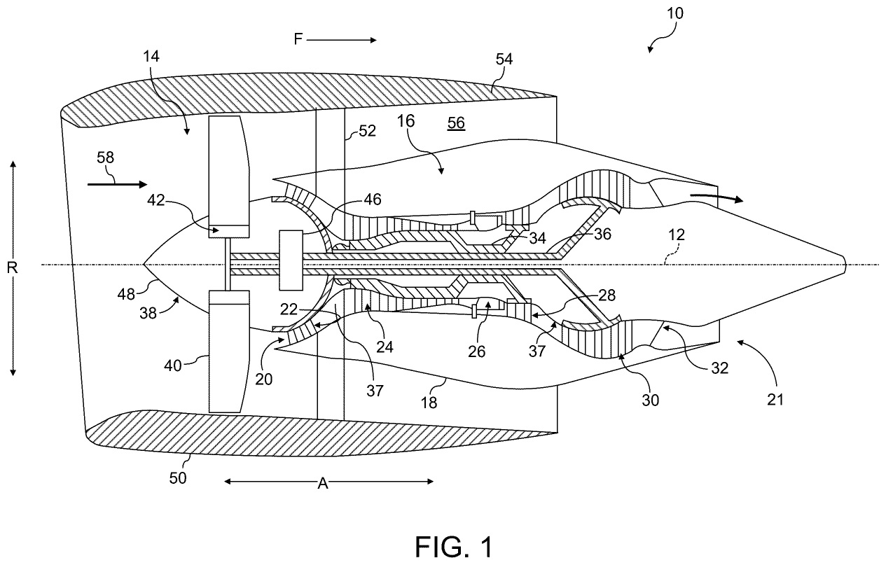

Referring now to the drawings, FIG. 1 is a schematic cross-sectional view of a gas turbine engine 10 in accordance with an exemplary embodiment of the present disclosure. More particularly, for the embodiment of FIG. 1, the gas turbine engine 10 is a high-bypass turbofan jet engine. As shown in FIG. 1, the gas turbine engine 10 defines an axial direction A (extending parallel to a longitudinal centerline 12 of the gas turbine engine 10 provided for reference) and a radial direction R. An airflow direction F is also defined, describing the general directional flow of air through the gas turbine engine 10 during normal operation such as takeoff and cruise. The gas turbine engine 10 may also define a circumferential direction C extending circumferentially about the axial direction A. In general, the gas turbine engine 10 includes a fan section 14 and a turbomachine 16 disposed downstream from the fan section 14.

The exemplary turbomachine 16 depicted is generally enclosed within a substantially tubular outer casing 18 that defines an annular inlet 20 and an annular exhaust 21. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft 36 or spool drivingly connects the LP turbine 30 to the LP compressor 22. The compressor section, combustion section 26, turbine section, and nozzle section 32 together define a core air flowpath 37 therethrough.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk is covered by a rotatable front hub 48 aerodynamically contoured to promote an airflow 58 through the plurality of fan blades 40. Additionally, the exemplary gas turbine engine 10 includes an annular nacelle assembly 50 that circumferentially surrounds the fan 38 and/or at least a portion of the turbomachine 16. For the embodiment depicted, the nacelle assembly 50 is supported relative to the turbomachine 16 by a plurality of circumferentially-spaced outlet guide vanes 52. Moreover, a downstream section 54 of the nacelle assembly 50 extends over an outer portion of the outer casing 18 so as to define a bypass airflow passage 56 therebetween. The ratio between a first portion of air through the bypass airflow passage 56 and a second portion of air through the inlet 20 of the turbomachine 16, and through the core air flowpath 37, is commonly known as a bypass ratio.

Additionally, as will be discussed in greater detail with reference to the exemplary embodiments below, the nacelle assembly 50 includes a thrust reverser assembly 100, which is depicted as a cascade thrust reverser assembly in a stowed position.

It should be appreciated that the exemplary gas turbine engine 10 depicted in FIG. 1 is by way of example only, and that in other exemplary embodiments, the gas turbine engine 10 may have any other suitable configuration, including, for example, any other suitable number of shafts or spools, a pitch change mechanism for the fan 38 (which would no longer be a fixed pitch fan), a reduction gearbox between the LP shaft 36 and the fan 38, etc.

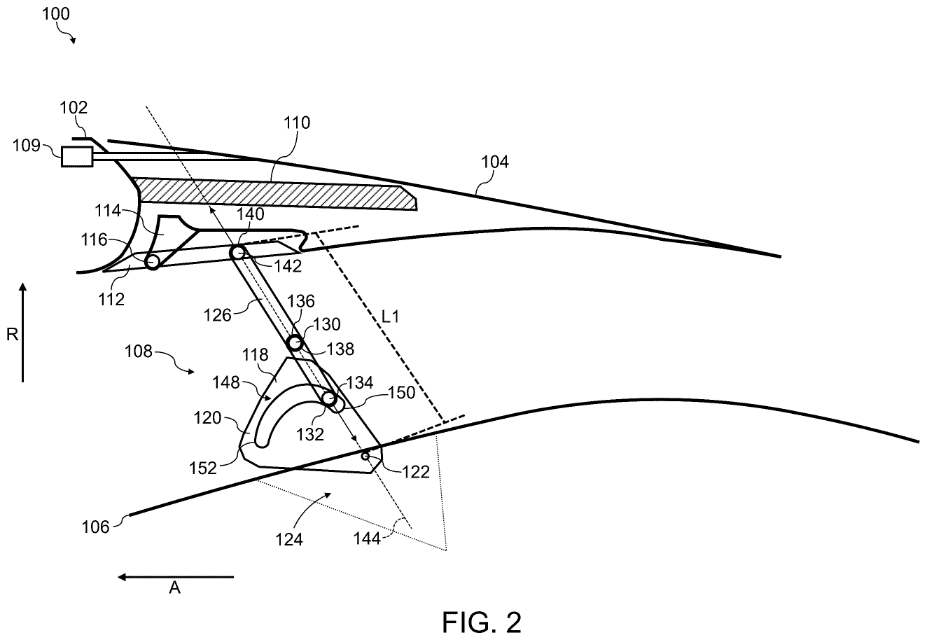

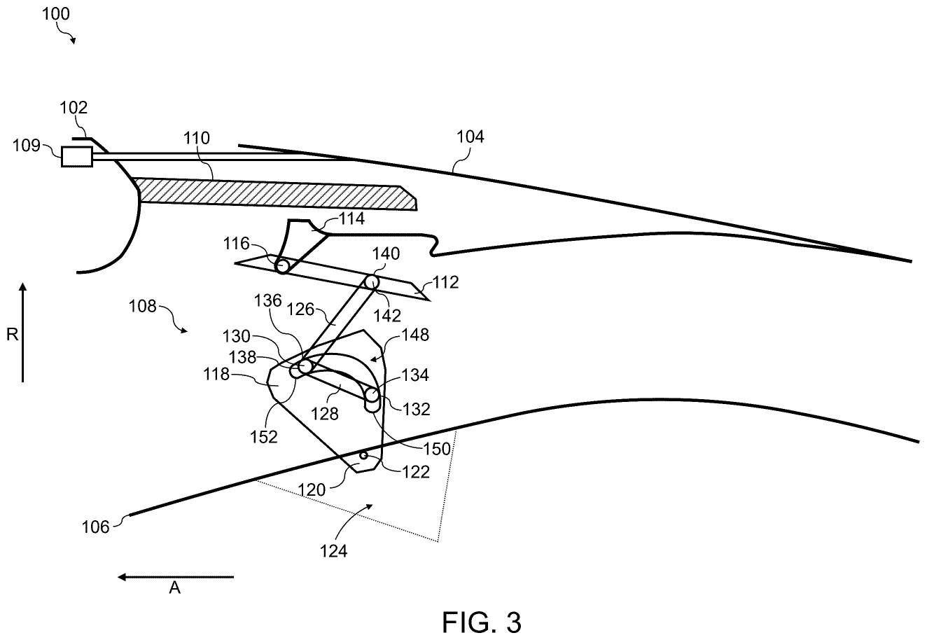

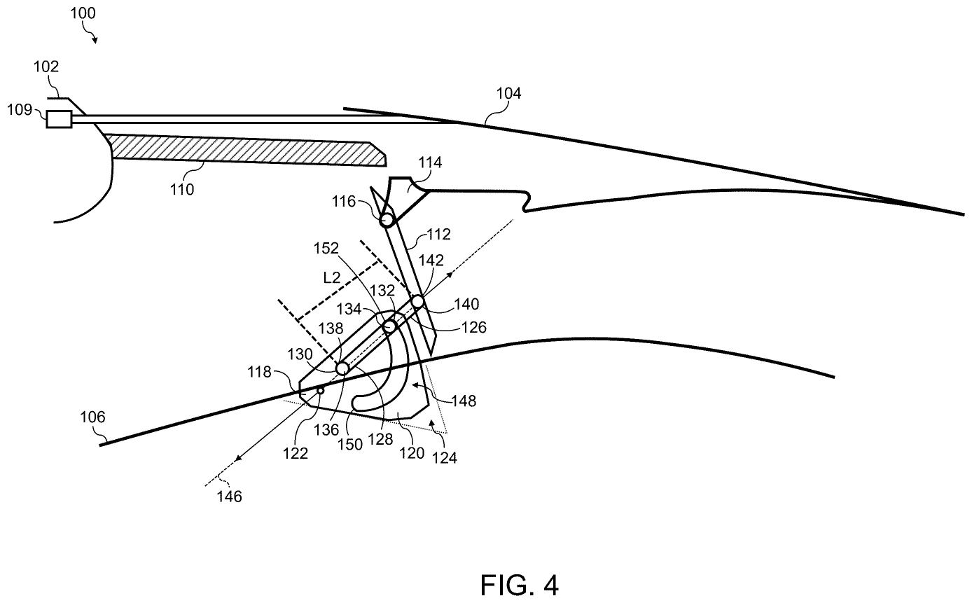

With reference to FIGS. 2-4, a schematic view of a thrust reverser assembly 100 is provided. FIG. 2 shows the thrust reverser assembly 100 in a stowed position. FIG. 3 shows the thrust reverser assembly 100 in an intermediate position. FIG. 4 shows the thrust reverser assembly 100 in a deployed position.

With reference to FIG. 2, the thrust reverser assembly 100 includes a thrust reverser fixed structure 102, a translating cowl 104, a core cowl 106, a deployment assembly 108, and a linear actuator 109 disposed in the thrust reverser fixed structure 102. The thrust reverser fixed structure 102 acts as an outer fixed structure, such that the translating cowl 104 and the thrust reverser fixed structure 102 form an aft end of the nacelle assembly 50. The core cowl 106 acts as an inner fixed structure to support the deployment assembly 108.

The translating cowl 104 is disposed aft of the thrust reverser fixed structure 102. The translating cowl 104 is movable from a stowed position (FIG. 2) to a deployed position (FIG. 4) in which the translating cowl 104 is spaced from the thrust reverser fixed structure 102. The linear actuator 109 moves the translating cowl 104 aft, away from the thrust reverser fixed structure 102. The translating cowl 104 forms an aftmost portion of the nacelle assembly 50, forming a nozzle with the core cowl 106 when the deployment assembly 108 is in the stowed position (FIG. 2).

The deployment assembly 108 extends from the core cowl 106 to the translating cowl 104 and is configured to expose a cascade assembly 110. That is, the cascade assembly 110 extends from the thrust reverser fixed structure 102 into the translating cowl 104 in the stowed position (FIG. 2), and in the deployed position (FIG. 4), the cascade assembly 110 is spaced from the translating cowl 104 and exposed to air flow. The cascade assembly 110 directs the air flow forward, reversing thrust for the gas turbine engine 10.

The thrust reverser assembly 100 includes a blocker door 112 rotatably coupled to the translating cowl 104. The blocker door 112 extends from the thrust reverser fixed structure 102 to the translating cowl 104 when the deployment assembly 108 is in the stowed position (FIG. 2), forming an inner surface of the nacelle assembly 50. In the deployed position (FIG. 4), the blocker door 112 contacts the core cowl 106 to drive air toward the cascade assembly 110. The blocker door 112 is rotatably coupled to the translating cowl 104 with a rotatable joint 114, which includes a pivot 116 about which the blocker door 112 rotates. The rotatable joint 114 is rotatable relative to the blocker door 112 and to the translating cowl 104, holding the translating cowl 104 aft of the thrust reverser fixed structure 102 in the deployed position (FIG. 4).

The deployment assembly 108 includes a rotating apparatus 118. The rotating apparatus 118 is configured to move in a manner to control movement of the blocker door 112, exposing the cascade assembly 110 for reverse thrust. In FIGS. 2-4, the rotating apparatus 118 is a cam 120 rotatably coupled to the core cowl 106 by a core cowl pivot 122. The cam 120 rotates about the core cowl pivot 122. In particular, the cam 120 is configured to rotate aft from the stowed position to the deployed position such that the cam 120 in the deployed position is disposed at least partially aft of the cam 120 in the stowed position. The core cowl 106 defines a cavity 124, shown only in FIG. 4, and in the deployed position, at least part of the cam 120 is disposed in the cavity 124.

The deployment assembly 108 includes a door link 126 and a cam link 128. The door link 126 is rotatably coupled to the blocker door 112, and the cam link 128 is movably coupled to the cam 120. The door link 126 and the cam link 128 are rotatably coupled to each other at a link pivot 130. Specifically, the cam link 128 has a first end 132 slidably coupled to the cam 120 at a cam pivot 134 and a second end 136, and the door link 126 has a first end 138 rotatably coupled to the second end 136 of the cam link 128 with the link pivot 130 and a second end 140 rotatably coupled to the blocker door 112 at a door pivot 142. As the translating cowl 104 is pushed aft by the linear actuator 109 in the axial direction A, the cam link 128 is rotated by the cam 120, the door link 126 rotates about the link pivot 130 and pulls the blocker door 112 away from the thrust reverser fixed structure 102.

In the stowed position (FIG. 2), the first end 132 of the cam link 128 is aligned with and spaced from the second end 140 of the door link 126. In particular, the door link 126 and the cam link 128 define a straight line. Specifically, the first end 132 and the second end 136 of the cam link 128 define a first line, the first end 138 and the second end 140 of the door link 126 define a second line, and the first line and the second line are collinear, shown as a common line 144. In such a form, tensile and compressive forces applied to the cam link 128 and the door link 126 are aligned, as indicated by the arrows, which reduces or inhibits movement of the blocker door 112 in the stowed position.

In the deployed position (FIG. 4), the first end 132 of the cam link 128 overlaps the door link 126, and the cam link 128 and the door link 126 are aligned with each other. Specifically, the first end 132 and the second end 136 of the cam link 128 define the first line, the first end 138 and the second end 140 of the door link 126 define the second line, and the link pivot 130 and the door pivot 142 define a third line. In the deployed position, the first line, the second line, and the third line are collinear, shown as a common line 146. In such a form, tensile and compressive forces applied to the cam link 128 and the door link 126 are aligned, as indicated by the arrows, which reduces or inhibits movement of the blocker door 112 in the deployed position.

In FIGS. 2-4, the cam link 128 is shorter than the door link 126, and it will be appreciated that the cam link 128 and the door link 126 may be sized to position the blocker door 112 in the deployed position (FIG. 4). The cam is configured to move the door link 126 toward and away from the blocker door 112 when rotating between the stowed position and the deployed position.

The cam 120 defines a slot 148 extending from a first end 150 to a second end 152. The first end 132 of the cam link 128 is slidably coupled to the slot 148, such that the cam link 128 slides along the slot 148 from the stowed position to the deployed position. Specifically, in the stowed position, the first end 132 of the cam link 128 is disposed at the first end 150 of the slot 148 (FIG. 2), in the intermediate position, the first end 132 of the cam link 128 is between the first and second ends 150, 152 of the slot 148 (FIG. 3), and in the deployed position, the first end 132 of the cam link 128 is disposed at the second end 152 of the slot 148 (FIG. 3). The slot 148 curves from the first end 150 to the second end 152 to allow the first end 132 of the cam link 128 to slide as the cam 120 rotates.

The deployment assembly 108 defines a first length L₁ between the core cowl pivot 122 and the second end of the door link 126 in the stowed position and a second length L₂ between the core cowl pivot 122 and the second end 140 of the door link 126 in the deployed position. The first length L₁ and the second length L₂ are different, and in FIGS. 2-4, the first length L₁ is greater than the second length L₂. By allowing the length between the core cowl pivot 122 and the second end 140 of the door link 126 to change from the stowed position to the deployed position, the deployment assembly 108 can position the blocker door 112 to reduce drag and improve design of the nacelle assembly 50. It will be appreciated that, in certain embodiments, the first length L₁ may be smaller than the second length L₂

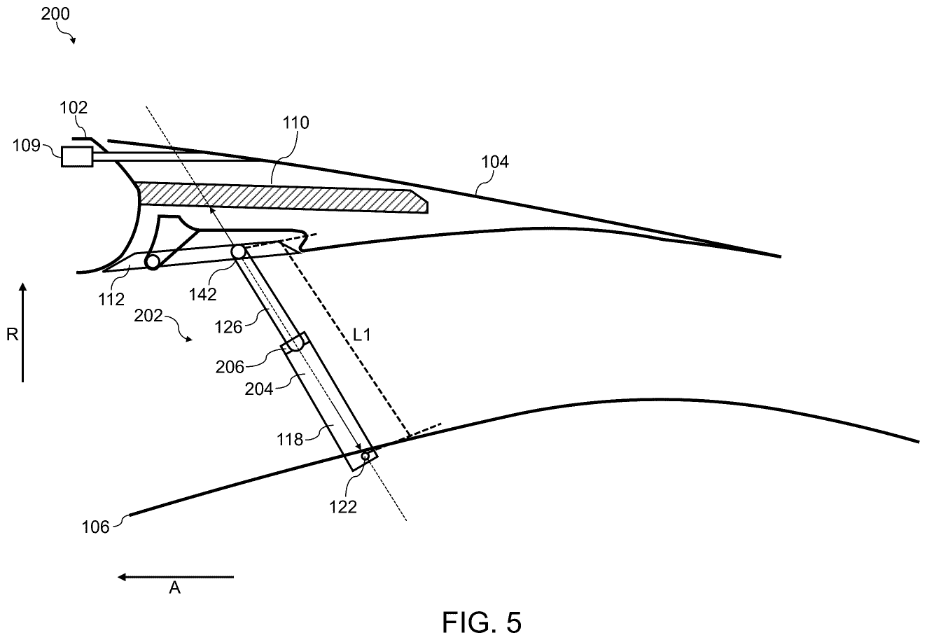

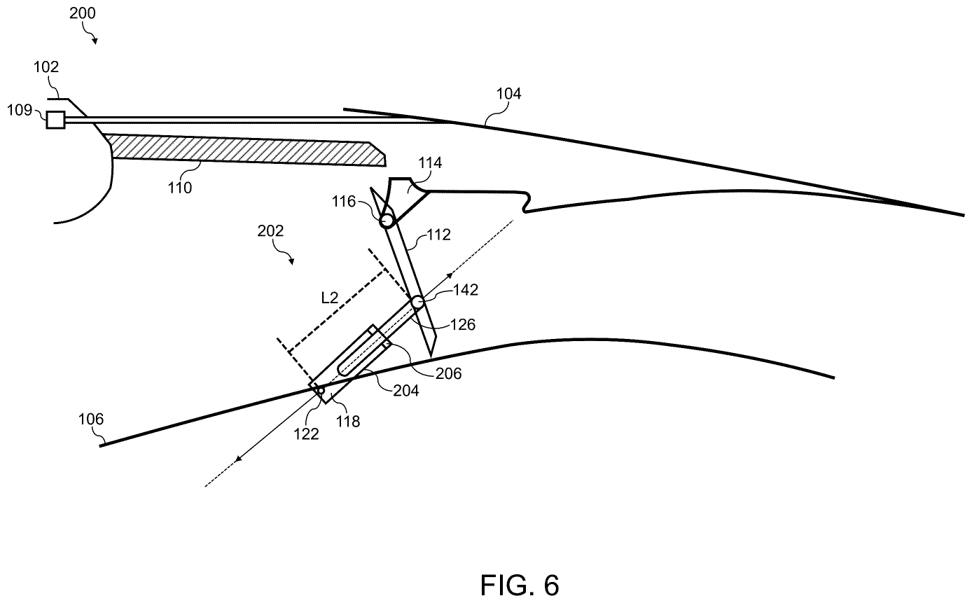

With reference to FIGS. 5-6, schematic views of another thrust reverser assembly 200 are provided. FIG. 5 shows a deployment assembly 202 of the thrust reverser assembly 200 in a stowed position. FIG. 6 shows the deployment assembly 202 of the thrust reverser assembly 200 in a deployed position. Similar components to those of the thrust reverser assembly 100 of FIGS. 2-4 will have similar numerals.

The deployment assembly 202 includes a door link 126 rotatably coupled to a blocker door 112 with a door pivot 142, a housing 204 rotatably coupled to the core cowl 106 by a core cowl pivot 122, and a lock 206 configured to hold the door link 126 in the housing 204 in the stowed position. Specifically, the housing 204 is configured to allow the door link 126 to move toward and away from the blocker door 112 in a linear manner as the housing 204 rotates from the stowed position to the deployed position. That is, the housing 204 and the door link 126 form a telescoping apparatus, where the door link 126 is movable into and out from the housing 204. In such a form, the housing 204 is a rotating apparatus 118, similar to the cam 120 of FIGS. 2-4.

In the stowed position (FIG. 5), the door link 126 extends outward from the housing 204 to hold the blocker door 112 against the thrust reverser fixed structure 102 and the translating cowl 104. As the housing 204 rotates when the linear actuator 109 moves the translating cowl 104 aft, the housing 204 retracts the door link 126, pulling the blocker door 112 toward the core cowl 106.

In the deployed position (FIG. 6), the door link 126 is nearly entirely disposed within the housing, and the blocker door 112 is positioned to direct air to a cascade assembly 110. Because the door link 126 is disposed within the housing 204, forces applied to the door link 126 and to the housing 204 are aligned, as shown by the arrows. Additionally, a first length L₁ between the core cowl pivot 122 and the door link 126 in the stowed position (FIG. 5) differs from a second length L₂ between the core cowl pivot 122 and the door link 126 in the deployed position (FIG. 6).

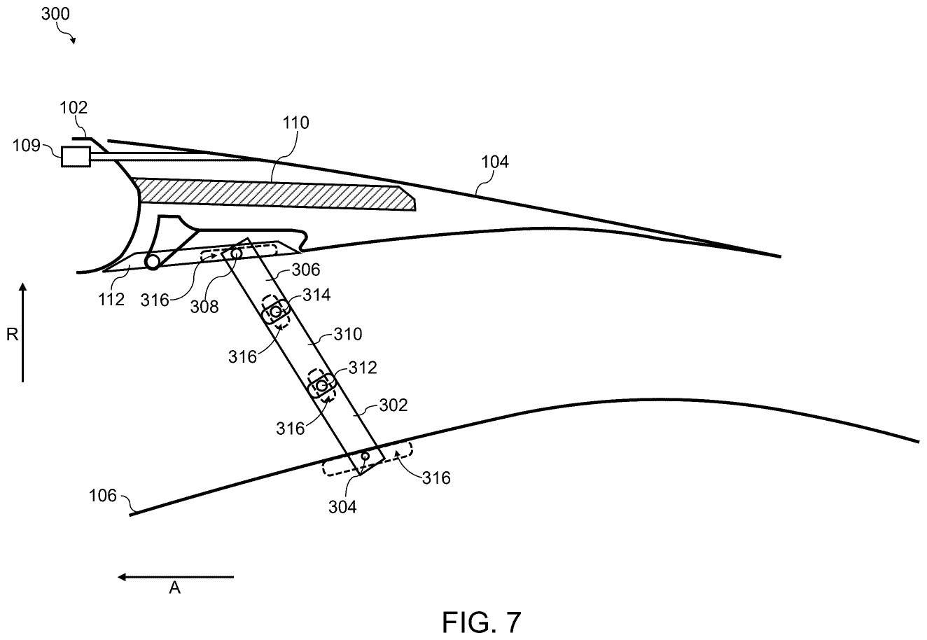

Now referring to FIG. 7, a schematic view of another thrust reverser assembly 300 is provided. The thrust reverser assembly 300 includes a first link 302 rotatably coupled to a core cowl 106 with a first pivot 304, a second link 306 rotatably coupled to a blocker door 112 with a second pivot 308, and a third link 310 rotatably connecting the first and second links 302, 306. Specifically, the third link 310 is rotatably connected to the first link 302 with a third pivot 312, and the third link 310 is rotatably connected to the second link 306 with a fourth pivot 314.

To allow for increased degrees of freedom for the thrust reverser assembly 300, each of the first, second, third, and fourth pivots 304, 308, 312, 314 (collectively, “the pivots”) is translatable along respective slots 316. That is, to allow the first, second, and third links 302, 306, 310 to rotate so that the blocker door 112 is positioned to direct air to the cascade assembly 110, one or more of the pivots may translate in the respective slot 316. The slots 316 may be designed such that, in the deployed position (not shown), the pivots are collinear.

Further aspects are provided by the subject matter of the following clauses:

A thrust reverser assembly for a gas turbine engine, the thrust reverser assembly including a blocker door rotatably coupled to a translating cowl and a deployment assembly coupled to the blocker door, the deployment assembly including a door link movably coupled to an inner fixed structure and movably coupled to the blocker door, and a rotating apparatus configured to move the door link toward and away from the blocker door, wherein the deployment assembly defines a first length in a stowed position between an end of the door link and an inner fixed structure, wherein the deployment assembly defines a second length in a deployed position between the end of the door link and the inner fixed structure, wherein the first length is different than the second length.

The thrust reverser assembly of any of the preceding clauses, wherein the rotating apparatus is a housing in which the door link is disposed.

The thrust reverser assembly of any of the preceding clauses, wherein the actuator is a cam and a cam link rotatably coupled to the door link.

The thrust reverser assembly of any of the preceding clauses, wherein the first length is greater than the second length.

The thrust reverser assembly of any of the preceding clauses, wherein the first length is smaller than the second length.

The thrust reverser assembly of any of the preceding clauses, wherein the deployment assembly further includes a lock configured to hold the door link in the rotating apparatus.

A thrust reverser assembly for a gas turbine engine, the thrust reverser assembly including an inner fixed structure, an outer fixed structure, a translating cowl disposed aft of the outer fixed structure, a blocker door rotatably coupled to the translating cowl, and a deployment assembly coupled to the blocker door, the deployment assembly including a cam rotatably coupled to the inner fixed structure, the cam defining a slot, a first link having a first end slidably coupled to the cam in the slot and having a second end, and a second link having a first end rotatably coupled to the second end of the first link and having a second end rotatably coupled to the blocker door, wherein the deployment assembly is movable from a stowed position in which the first end of the first link is aligned with and spaced from the second end of the second link to a deployed position in which the first end of the first link overlaps the second link.

The thrust reverser assembly of any of the preceding clauses, wherein the slot defines a first end and a second end, wherein in the stowed position, the first end of the first link is disposed at the first end of the slot, and wherein in the deployed position, the first end of the first link is disposed at the second end of the slot.

The thrust reverser assembly of any of the preceding clauses, wherein the slot curves from the first end to the second end.

The thrust reverser assembly of any of the preceding clauses, wherein the cam in the deployed position is disposed at least partially aft of the cam in the stowed position.

The thrust reverser assembly of any of the preceding clauses, wherein the inner fixed structure defines a cavity, and the cam is disposed at least partially in the cavity in the deployed position.

The thrust reverser assembly of any of the preceding clauses, wherein the cam is configured to rotate aft from the stowed position to the deployed position.

The thrust reverser assembly of any of the preceding clauses, wherein the first link is configured to rotate forward from the stowed position to the deployed position, and the second link is configured to rotate aft from the stowed position to the deployed position.

The thrust reverser assembly of any of the preceding clauses, wherein, in the deployed position, the first link and the second link are aligned with each other.

The thrust reverser assembly of any of the preceding clauses, wherein the cam is rotatably coupled to the inner fixed structure at a first pivot and the blocker door is rotatably coupled to the second link at a second pivot.

The thrust reverser assembly of any of the preceding clauses, wherein, in the deployed position, the first end of the first link and the second end of the first link define a first line, the first end of the second link and the second end of the second link define a second line, and the first pivot and the second pivot define a third line, wherein the first line, the second line, and the third line are collinear.

The thrust reverser assembly of any of the preceding clauses, wherein, in the deployed position, the blocker door contacts the inner fixed structure.

The thrust reverser assembly of any of the preceding clauses, wherein the first pivot is translatable along the inner fixed structure.

The thrust reverser assembly of any of the preceding clauses, wherein the second pivot is translatable along the blocker door.

The thrust reverser assembly of any of the preceding clauses, wherein, in the deployed position, the translating cowl is spaced from the outer fixed structure.

The thrust reverser assembly of any of the preceding clauses, wherein the outer fixed structure is a thrust reverser fixed structure.

The thrust reverser assembly of any of the preceding clauses, wherein the inner fixed structure is a core cowl.

The thrust reverser assembly of any of the preceding clauses, further including a cascade assembly extending from the outer fixed structure toward the translating cowl.

The thrust reverser assembly of any of the preceding clauses, wherein the blocker door is rotatably coupled to the translating cowl with a rotatable joint.

The thrust reverser assembly of any of the preceding clauses, wherein the first link is shorter than the second link.

The thrust reverser assembly of any of the preceding clauses, further including a linear actuator disposed in the outer fixed structure and configured to move the translating cowl aft.

A gas turbine engine including a turbomachine including, in serial flow order, a compressor section, a combustion section, and a turbine section, a cascade assembly, and a thrust reverser assembly including an inner fixed structure, an outer fixed structure, a translating cowl disposed aft of the outer fixed structure, a blocker door rotatably coupled to the translating cowl, and a deployment assembly coupled to the blocker door and configured to move the blocker door to expose the cascade assembly, wherein the thrust reverser assembly defines a first length in a stowed position between the blocker door and the inner fixed structure, wherein the thrust reverser assembly defines a second length in a deployed position between the blocker door and the inner fixed structure, wherein the first length is different than the second length.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A thrust reverser assembly for a gas turbine engine, the thrust reverser assembly comprising:
a blocker door rotatably coupled to a translating cowl; and
a deployment assembly coupled to the blocker door, the deployment assembly comprising:
a door link movably coupled to an inner fixed structure of the gas turbine engine and movably coupled to the blocker door; and
a rotating apparatus configured to move the door link, the door link being translatable within the rotating apparatus, the door link and the rotating apparatus forming a telescoping apparatus,
wherein the deployment assembly defines a first length in a stowed position between an end of the door link and the inner fixed structure,
wherein the deployment assembly defines a second length in a deployed position between the end of the door link and the inner fixed structure, and
wherein the first length is different than the second length.

2. The thrust reverser assembly of claim 1, wherein the rotating apparatus is a housing in which the door link is disposed.

3. (canceled)

4. The thrust reverser assembly of claim 1, wherein the first length is greater than the second length.

5. (canceled)

6. The thrust reverser assembly of claim 1, wherein the deployment assembly further comprises a lock configured to hold the door link in the rotating apparatus.

7. A thrust reverser assembly for a gas turbine engine, the thrust reverser assembly comprising:
an inner fixed structure;
an outer fixed structure;
a translating cowl disposed aft of the outer fixed structure;
a blocker door rotatably coupled to the translating cowl; and
a deployment assembly coupled to the blocker door, the deployment assembly comprising:
a cam rotatably coupled to the inner fixed structure, the cam defining a slot;
a first link having a first end slidably coupled to the cam in the slot and having a second end; and
a second link having a first end rotatably coupled to the second end of the first link and having a second end rotatably coupled to the blocker door,
wherein the deployment assembly is movable from a stowed position in which the first end of the first link is aligned with and spaced from the second end of the second link to a deployed position in which the first end of the first link overlaps the second link.

8. The thrust reverser assembly of claim 7, wherein the slot defines a first end and a second end, wherein in the stowed position, the first end of the first link is disposed at the first end of the slot, and wherein in the deployed position, the first end of the first link is disposed at the second end of the slot.

9. The thrust reverser assembly of claim 7, wherein the cam in the deployed position is disposed at least partially aft of the cam in the stowed position.

10. The thrust reverser assembly of claim 7, wherein the inner fixed structure defines a cavity, and the cam is disposed at least partially in the cavity in the deployed position.

11. The thrust reverser assembly of claim 7, wherein the cam is configured to rotate aft from the stowed position to the deployed position.

12. The thrust reverser assembly of claim 7, wherein the first link is configured to rotate forward from the stowed position to the deployed position, and the second link is configured to rotate aft from the stowed position to the deployed position.

13. The thrust reverser assembly of claim 7, wherein, in the deployed position, the first link and the second link are aligned with each other.

14. The thrust reverser assembly of claim 7, wherein the cam is rotatably coupled to the inner fixed structure at a first pivot and the blocker door is rotatably coupled to the second link at a second pivot.

15. The thrust reverser assembly of claim 14, wherein, in the deployed position, the first end of the first link and the second end of the first link define a first line, the first end of the second link and the second end of the second link define a second line, and the first pivot and the second pivot define a third line, wherein the first line, the second line, and the third line are collinear.

16. The thrust reverser assembly of claim 7, wherein, in the deployed position, the translating cowl is spaced from the outer fixed structure.

17. The thrust reverser assembly of claim 7, wherein the outer fixed structure is a thrust reverser fixed structure.

18. The thrust reverser assembly of claim 7, wherein the inner fixed structure is a core cowl.

19. The thrust reverser assembly of claim 7, further comprising a cascade assembly extending from the outer fixed structure toward the translating cowl.

20. A gas turbine engine comprising:
a turbomachine comprising a compressor section, a combustion section, and a turbine section;
a cascade assembly; and
a thrust reverser assembly comprising:
an inner fixed structure;
an outer fixed structure;
a translating cowl disposed aft of the outer fixed structure;
a blocker door rotatably coupled to the translating cowl; and
a deployment assembly coupled to the blocker door and configured to move the blocker door to expose the cascade assembly, the deployment assembly comprising:
a cam rotatably coupled to the inner fixed structure, the cam defining a slot;
a first link having a first end slidably coupled to the cam in the slot and having a second end; and
a second link having a first end rotatably coupled to the second end of the first link and having a second end rotatably coupled to the blocker door,
wherein the thrust reverser assembly defines a first length in a stowed position between the blocker door and the inner fixed structure,
wherein the thrust reverser assembly defines a second length in a deployed position between the blocker door and the inner fixed structure,
wherein the first length is different than the second length, and
wherein the deployment assembly is movable from a stowed position in which the first end of the first link is aligned with and spaced from the second end of the second link to a deployed position in which the first end of the first link overlaps the second link.
